(19) United States
(12) Patent Application Publication
(10) Pub. No.: US 2010/0057408 A1
(43) Pub. Date: Mar. 4, 2010

(54) FAST MULTIPHYSICS DESIGN AND SIMULATION TOOL FOR MULTITECHNOLOGY SYSTEMS

(75) Inventors: Vikram Jandhyala, Seattle, WA (US); Indranil Chowdhury, San Jose, CA (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 12/199,277

(22) Filed: Aug. 27, 2008

(51) Int. Cl. G06F 7/60; G06F 17/10

(52) U.S. Cl. 703/2

(57) ABSTRACT

In one exemplary approach, a Schur complement-based boundary element method (BEM) is employed for predicting the motion of arbitrarily shaped three-dimensional particles under combined external and fluidic force fields. The BEM relies on modeling the surface of the computational domain, significantly reducing the number of unknowns when compared to volume-based methods. In addition, the Schur complement-based scheme enables a static portion of the computation to be computed only once for use in subsequent time steps, which leads to a tremendous reduction in solution time during time-stepping in the microfluidic domain. Parallelized oct-tree based O(N) multilevel iterative solvers are also used to accelerate the setup and solution costs.

### GOVERNMENT RIGHTS

This invention was made with government support under Grant No. EEC0203518 awarded by the National Science Foundation (NSF). The government has certain rights in the invention.

### BACKGROUND

As a result of improvements in circuit miniaturization, new devices are becoming increasingly smaller, making it possible to integrate multiple technologies that have previously been produced as separate devices. Miniaturization and device integration are thus becoming increasingly important, particularly in the development of lab-on-chip (LoC) devices. However, the design tools used for creating such complex devices tend to lag behind the development of the devices. For example, the designer of a LoC device may use a mechanical design system for drawing the device and some combination of other design analysis tools to simulate limited aspects of the design. Combining the results of these limited simulations is an engineering art.

Many LoC devices use dielectrophoretic (DEP) manipulation of polarized species inside microfluidic channels, in addition to applying other types of forces that affect the motion of bio-particles through the fluid channels. Understanding the fluidic and electromagnetic forces in these devices requires rigorous treatment of the underlying physics. A boundary element method (BEM)-based system matrix can be used to solve for the motion of particles through a fluidic channel in a LoC device; however, the BEM matrix is dense in nature due to the highly coupled interaction between the walls of the channel and the particles, especially when the particle size is comparable to that of the channels. FIG. 3 illustrates an example of a particle 60 within a fluid channel 62 having walls 64 and 66. Conventionally, the numerical treatment of such systems is achieved via a direct “brute-force” computation of the whole fluidic domain during each time-step of the iteration. Further, during computation of the motion of rigid or deformable particles within a fluid channel, a large number of time steps are required (e.g., several thousand), and each time step consists of a computationally expensive solution of a dense matrix system. The conventional approach is so computationally expensive that it can literally take hours to complete each iterative step on a typical personal computer. Previous work on LoC modeling has primarily been based on finite-element and volume based methods. The problem with these methods lies in the fact that they need to remesh the whole channel for each time step, which further adds to the complexity and computational expense. By modeling a LoC design before it is submitted to manufacture, the details of the design can be optimized, thereby avoiding expensive changes to address performance issues after production is started.

Thus, it would be desirable to develop an approach that can efficiently compute the motion of particles within a fluidic channel. With this approach, a user should be able to design a device by integrating different components that are supported by physics-level solvers and then determine the effects of changes to the design to achieve a desired (or optimal) level of performance. For example, such an approach might be capable of simulating the effects of electromagnetic fields, electro-fluidic forces, particle/molecular/cellular motions, diffusion, electrophoresis, dielectrophoresis, photonics, and gravitation—and any desired combination of these parameters, in regard to their affect on the motion of particles through the device.

While an initial application for such an approach to more efficiently determine the motion of particles through a fluid channel is in the emerging LoC technology, this is just one application of this approach. It should be apparent that there are many other different kinds of applications that might benefit from using this new and more efficient technique.

### SUMMARY

Accordingly, one aspect of the novel technology described below is directed to a method for efficiently determining the motion of a particle through a fluid channel in response to forces and torques acting on the particle in a series of successive time intervals. The method provides for creating a description of a mesh that defines boundary surfaces of the fluid channel, as well as a mesh that defines a surface of the particle (or particles) moving through the fluid channel. The method is particularly useful when the particle or particles involved within a fluid channel is/are so small compared to the fluid channel that the number of mesh elements describing the particle/particles is small compared to the mesh of the fluid channel boundary. A system of equations is formulated to define force and velocity interactions between the particle and the fluid channel that affect the movement of the particle through the fluid channel. The system of equations employed will depend upon the specific forces acting on the particle. Based on the system of equations, a next step of the method then determines several matrices. A first matrix defines an interaction between the boundary surface of the fluid channel and itself. Values comprising the first matrix remain constant in time as the particle moves through the fluid channel. A second matrix is determined that defines an interaction between the particle and itself. Values comprising the second matrix remain constant in time if the particle is rigid, but can change over time if the particle deforms (i.e. changes size and/or shape) while moving through the fluid channel. Also determined are a third matrix that defines an interaction between the particle and the fluid channel and a fourth matrix that defines an interaction between the fluid channel and the particle. Values comprising the third matrix and the fourth matrix vary in time as the particle moves through the fluid channel. Next, an inverse of the first matrix is determined for use in the Schur complement; also used in the Schur complement are the second, third, and fourth matrices. For each successive time interval, the Shur's complement is iteratively updated to determine a dynamic behavior of the particle as it moves through the fluid channel. The dynamic behavior of the particle is indicated by a velocity at an input face and at an output face of the fluid channel, by forces on the boundary surfaces of the fluid channel, and by traction forces on the surface of the particle for the time interval. The dynamic behavior of the particle that is thus determined for the successive intervals of time is then employed to implement a physical result related to the movement of the particle through the fluid channel.

The physical result can comprise carrying out one or more steps that include displaying a visual representation corresponding to the dynamic behavior of the particle moving through the channel; employing the dynamic behavior of the particle for a design iteration to modify or optimize parameters affecting movement of particles within the fluid channel; and, storing values representative of the dynamic behavior of the particle as it moves through the fluid channel, for subsequent display or use by a user.

The step of formulating the system of equations can comprise the step of creating an integral representation of the particle movement through the fluid channel for incompressible Stokes fluid flow.

The method further includes the step of applying no-slip and pressure boundary conditions to the boundary surface of the fluid channel when formulating the system of equations. Further, the step of applying no-slip boundary conditions to the boundary surface of the fluid channel can include the step of setting velocity components at the boundary surfaces equal to zero.

Another step of the method is directed to accounting for traction forces applied at inlet and outlet faces of the fluid channel, based on pressure gradients within the fluid channel. The step of formulating the system of equations further includes the step of accounting for net external forces and torque applied to the surface of the particle that produce translational and rotational velocities of the particle as it moves through the fluid channel.

The step of determining the inverse of the first matrix can include the step of employing a low rank-based fast solver to determine the inverse. The method will typically include the step of storing the inverse of the first matrix after it is determined for a first of the successive time intervals, so that the inverse can be recalled from the storage and used in updating the Schur complement for each of the remaining successive time intervals. If the second matrix includes values that are invariant for successive time steps, the method may further instead include the step of storing the second matrix, so that it can be recalled from storage and used in updating the Schur complement for each of the successive time intervals.

Another aspect of the present novel approach is directed to a system that includes a memory in which are stored machine executable instructions, a display, and a processor that is coupled to the memory and the display. The processor executes the machine executable instructions to carry out a plurality of functions that are generally consistent with the steps of the method described above.

Yet another aspect of the present approach is directed to a memory medium storing machine readable and executable instructions for determining the motion of a particle through a fluid channel, so that when executed, the machine instructions cause functions generally consistent with those of the method discussed above to be executed.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a schematic functional block diagram of a simulated LoC device in which a DEP force is applied to affect a bio-particle being carried by a fluid through a fluid channel of the simulated device;

FIG. 2 is an exemplary functional block diagram of a general procedure that can be used for determining the motion of one or more particles in a microfluidic design environment for a LoC device or other type of fluid channel system;

FIG. 3 is a schematic diagram illustrating the cross-coupling due to an interaction between fluid channel walls and a particle in a fluid channel;

FIG. 4 illustrates an exemplary flow field distribution in a complicated fluid channel topology;

FIG. 5 illustrates an exemplary DEP field distribution due to a V-shaped electrode array in a LoC device or other fluid channel system;

FIG. 6 is a graph illustrating the speedup per time step provided by the present approach over the conventional direct solution, as a function of the number of unknowns being determined, where the speedup indicates the ratio of the time required for the direct approach and the time required to calculate the dynamic motion of a particle with the present approach;

FIG. 7 is an exemplary display showing a simulation of a blood platelet moving through a pressure driven micro-fluid channel, to illustrate how the present approach can be employed for displaying the motion of a particle in a fluid channel, where the dynamic motion of the particle is determined by the present approach;

FIG. 8 is a schematic diagram illustrating how a DEP force on a bio-particle is found for use in determining the dynamic motion of the bio-particle through a fluid channel, using the present approach;

FIG. 9 illustrates an exemplary triangular mesh of the surface of a generally spheroidal particle, such as a yeast cell, for use in evaluating the DEP force on the particle in connection with determining the dynamic motion of the yeast cell through a fluid channel, using the present approach;

FIG. 10 is a schematic illustration of a pulse basis function for a triangle (i.e., for an element of a surface mesh of a particle);

FIG. 11 is an exemplary plot of a high gradient electric field intensity produced by a two-phase planar electrode array, which acts on particles in a fluid channel as an external force;

FIG. 12 is a schematic diagram illustrating flow streamlines inside an “H-shaped” channel and is a further example of a more complex, non-linear fluid channel to which the present approach is applicable;

FIG. 13 is a schematic diagram illustrating the mesh of a four-arm spiral inductor with a superimposed plot of electric field intensity, wherein the strength of the electric field intensity is strongest near the edges of the electrodes and increases in strength toward the center of the array, as an example showing EM forces applied to particles moving within a fluid channel; and

FIG. 14 is a functional block diagram illustrating the functional components of an exemplary personal computer or other computing device that is suitable for use as a system for executing the steps of the novel method described herein.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

### Microfluidic Devices—for Example—Lab on Chip

Microfluidic devices can give researchers the ability to manipulate, sort, store, and analyze biological cells and macromolecules (among other tasks). Techniques such as capillary electrophoresis, flow cytometry, and dielectrophoresis have been applied to various applications, such as single cell analysis, drug development, tissue engineering, and evaluation of biosensors, to name only a few without any implied limitation. These techniques can be employed in a LoC, which can be fabricated as small, inexpensive, integrated circuit microfluidic devices that can replace much larger and relatively expensive bench-sized chemical analyzers.

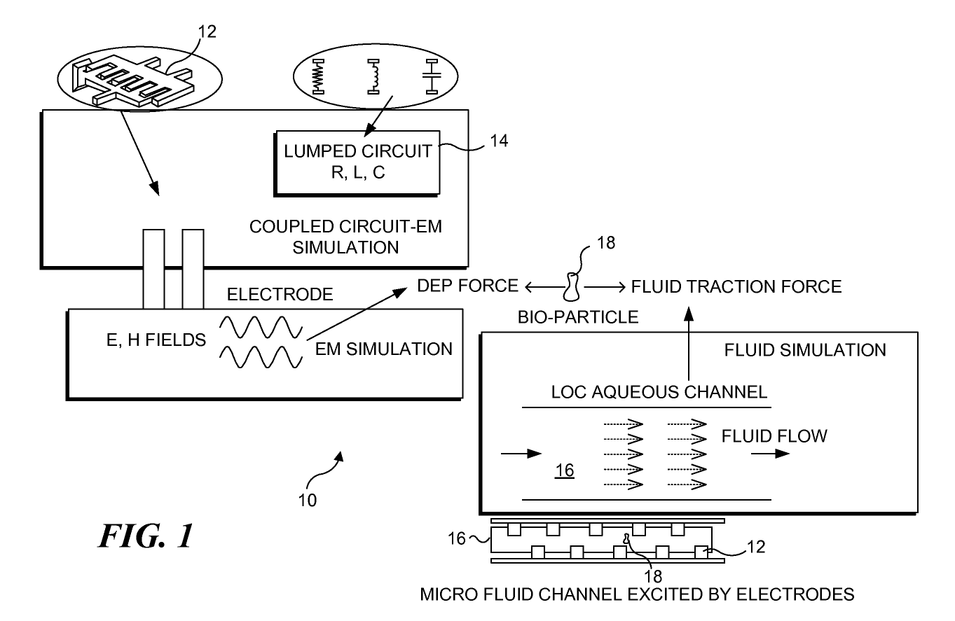

LoC devices have become so small, so integrated, and so sensitive that the design processes used to create them face significant challenges. Simulation-based paradigms and design automation tools already exist for creating such devices. However, the tools available for this purpose have not kept pace with the evolution of LoC systems. Today's lab-on-chip technologies are multi-technology integrated platforms (e.g., devices that can combine microfluidics, microelectronics, MEMS, and biological constituents), as will be evident in a schematic diagram 10 that is shown in FIG. 1. As illustrated in this Figure, a LoC can include a relatively complex shaped electrode 12, which produces E, H fields that act on particles within a fluid channel of the LoC. A coupled circuit that produces a simulation of EM effects can be represented in a simulation of the device as a lumped circuit 14 and defined by its resistance, inductance, and capacitance (R, L, C). In connection with the simulation of a LoC, it will typically be desirable to determine the dynamic motion of a particle 18 as it moves through a micro fluid channel 16 within the LoC and experiences one or more external forces and torques, such as a DEP force produced by electrodes.

Specific arrangements of electrodes disposed along the walls of the fluid channel can be modeled, and their effect on the motion of the particles in the fluid channel can be determined by the conventional direct approach. However, the onerous task of computing details of how a particle moves through the fluid channel in such a device has stood in the way of refining or optimizing the design parameters when producing a commercially acceptable product of this type. The present approach provides a means to overcome such problems, by enabling a user to model parameters related to the fluid channels in LoC devices that affect the movement of particles through the fluid channel in a LoC and determine the resulting dynamics of the particle motion in an efficient manner. It should be emphasized, however, that the present approach can also be used for determining the movement of particles in fluid channels in many other types of devices and systems besides a LoC.

There are a number of problems that can arise when creating or evaluating LoC technologies and refining the design of such systems. Design paradigms must provide designers a direction and analysis in developing, designing, and prototyping their devices. Designers must be able to quantifiably account for the myriad of multi-physics physical parameters that can possibly occur on any given platform. Rapid design times are essential. Design insight is necessary in order to predict a direction for prototyping a design and to enable high performance and optimized design under multivariable constraints. The configuration of a fluid channel in a device can be relatively complex, as illustrated by a fluid channel 70 shown in FIG. 4 in relation to its flow field distribution. This exemplary fluid channel includes three inlet branches 72, 74, and 76, which join in a common portion 78. The common portion then branches into two angled outlet channels 80 and 82. Another example of the problems facing a designer is illustrated in FIG. 5, which shows a fluid channel configuration 90 having fluid channels 92, and an overlying DEP field distribution 94 that is due to a V-shaped electrode array. Clearly, determining how this DEP field distribution affects the motion of particles in the fluid channel represents a non-trivial problem. Thus, as will be evident from the examples of FIGS. 4 and 5, it is a significant challenge to determine particle movement within the fluid channel(s) of a design in a reasonably efficient manner, since the channel configuration and the forces acting on the particles in such channels can be relatively complex and involve many variables that change over time.

The present exemplary approach is directed to a method that is able to generate novel solutions for LoC designs, to enable the designer to combine fast, high resolution simulations with robust design tradeoff characterizations. This approach can accelerate simulations to evaluate design changes and thus, achieve faster design times. Modeling platforms, such as can be implemented using the present approach, that can solve for particle motion in the fluid channel of simulation models with high resolution and in a short time period, are very desirable. The present approach can also provide design insight, variability-awareness, and fabrication tolerance to enable higher yield and device performance when simulating a LoC and other device and system technologies prior to production.

One advantage of the present approach over existing solvers arises from its use of advanced “fast” physics-based solvers, and based upon the parameters thus determined, the present approach enables particle dynamic motion to be much more quickly determined. The present approach uses a software implementation that can provide orders of magnitude faster design times compared to present commercial software and thus provide faster-to-market solutions for LoC and other system designers.

More specifically, the present approach employs a numerical technology to determine accurate pressure-velocity characteristics within a three-dimensional, arbitrary-shaped micro fluid channel. Flow-fields, forces and torques, and velocities of fluid within a micro fluid channel are calculated using a surface-based integral equation method, which relies on a computation of the surface traction forces and velocities (two unknowns), induced by a pressure-gradient applied to the ends of a micro fluid channel.

The microfluidic BEM can determine the surface velocities and traction forces on every surface bounding the problem, including 3-D particles. The particles may be of arbitrary-shape, may be conveyed by a different fluid (i.e., by using a two-fluid integral equation), and may have applied forces and torques induced on them. In solving the microfluidic integral equation, the unknown velocities and forces on the particles are also determined. By balancing this microfluidic force with other external forces, the particle's motion can then be determined. As a post-processing step for each microfluidic solution, a Newtonian force time-stepper can be used to update the particle velocity (rotational and translational velocity) under a rigid body (e.g., solid), or with a non-rigid body assumption (e.g., a fluid). Once the velocities have been determined, the spatial positioning or movement of a particle or an object may be updated over time (i.e., in successive time steps or intervals) to define the motion of the particle as it moves through the fluid channel.

The microfluidic integral equations are solved using a Fast, QR BEM method (e.g., Fast Solver stage) and a Schur complement (e.g., Design stage) to determine the surface traction forces and velocities on bounding surfaces within the problem.

The integral representation for incompressible Stokes flow is given by the following expressions:

$${u}_{i} ( {x}_{0} ) = \frac{- 1}{4 π μ} {\int }_{D} {G}_{ij} ( x , {x}_{0} ) {f}_{j} ( x ) d S ( x ) + \frac{1}{4 π} {\int }_{D}^{PV} {u}_{j} ( x ) {T}_{ijk} ( x , {x}_{0} ) {n}_{k} ( x ) d S ( x ) .$$

No-slip and pressure boundary conditions are applied on the surface of the channel, while force and torque balance equations are setup for rigid particles,

$${\int }^{•} σ• d S = {F}_{ext} ; {\int }^{•} r \times ( σ• d S ) = {T}_{ext} ; {u}_{particle} = U + Ω \times r$$

where U and Ω are the translation and angular velocities. The external forces and torques can be DEP fields, for example. The surface of the domain is discretized using triangular (or rectangular or other polygon shape) patches and subsequently, a collocation method is used for solving the unknown traction and velocity fields. The particle velocities can be solved at each time step or interval, and the resulting trajectory of the particle can be determined. However, directly solving the whole dense matrix system for each time step becomes prohibitively expensive (in terms of computational time). An algorithm to reduce this computational cost is described below.

The first step in this algorithm is the isolation of the particle under study, which is achieved by identifying the patches belonging to the mathematical surface bounding the particle Sₚ. This surface isolates the problem into two parts—a subset of the problem that is constant over time and another part, which is changing over time. All of the force and velocity unknowns belonging to the fluid channel constitute the first part (i.e., a matrix D), which consists of the single and double layer interactions of the channel walls and faces, in other words, the interaction of the fluid channel with itself. Similarly, all the force unknowns belonging to the particle are represented by a matrix A, which consists of the single layer interactions among the particle patches, in other words, the interaction of the particle with itself. Note that this decomposition does not change the integral equations of the equivalent problem when a change in the shape or location of the object bounded by Sₚ occurs. A small change in the shape of Sₚ may not require additional patches; however, if the shape and/or size of the particle substantially changes (e.g., if the particle is deformable) it may be necessary to add more patches to the particle surface, to maintain a desired level of accuracy. In this case, matrix A will vary over time.

As a result of decomposing, the actual problem can be thought of as four different parts: (1) the channel interacting with itself (matrix D), which is invariant over time as the particle moves through the fluid channel; (2) the particle interacting with itself (matrix A), which is also invariant over time unless the particle is deforming (changes in shape and/or size); the channel to particle interaction (a matrix B); and the particle-to-channel interaction (a matrix C). Matrix B contains both single and double layer interactions, while matrix C includes only single layer interactions. Both matrices B and C include values that can vary with successive time steps as the particle moves through the fluid channel.

The resulting system can be described by the following system of equations:

Dy+Cx=a₁

By+Ax=a₂

Since the channel walls are static and unchanging in time, the matrix D is constructed and then inverted—but only once, during the first time step. If matrix A is invariant, then matrix A may also be stored. The inverted form, D⁻¹ is then stored for use in subsequent time steps or interval computations. The Schur complement, which includes the unchanging part (inverted matrix D and matrix A—if the particle is not changing in either size or shape as it moves through the fluid channel) is given by S=A−BD⁻¹C. At each time step, the Schur complement is updated for new values of the varying matrices, but the stored value for the inversion of matrix D is used at each time step. The unknowns are computed by back-substitution using a standard Schur complement method, as will be well-known to those of ordinary skill in the art of linear algebra. Therefore, for each time step or interval of the iteration, the dimension of the net system is greatly reduced, because the inverted form of matrix D does not change, which saves considerable computational cost. Even with modern powerful personal computers, the inversion of matrix D can require hours of computation time when the number of mesh elements is large. It is important to note that the proposed technique bypasses the cost of explicit modeling of the mutual coupling between the channel walls and the particles.

In an example of the present approach, the surface traction forces in both the fluid channel and the particle problems are implemented, and to simplify the example, the particle is treated as a rigid body and its shape is constant in time. However, the methodology presented here is generally equally valid for deformable particles whose shape and/or size change over time. The surface of the fluid channel supports both velocity and force unknowns, while the particle surface supports only force unknowns. In order to take into account the translation and rotational velocities of the particle, the net external force and external torque have to be imposed on its surface. On the fluid channel walls, three orthogonal components of the velocity are set to zero in order to enforce no-slip conditions. The traction forces on the fluid channel faces (the inlet and outlet faces of the fluid channel) are determined by the imposed pressure gradient. Note that the velocities at the channel faces are unidirectional, i.e., directed into the fluid channel at the inlet face and out of the fluid channel at the outlet face.

An appropriate pre-conditioner can be applied during use of the fast solver when required. The traction forces on the particle surface are unknowns and the double layer contribution due to a closed particle is zero outside its boundary. Combining all the interactions, along with the force and torque balance equations, the overall system is written in a matrix form, as follows:

$$[ \begin{matrix}D & C \\ B & A \\ \sum F & \\ \sum T & \end{matrix} ] [ \begin{matrix}{f}_{c} \\ {u}_{c} \\ {f}_{p}\end{matrix} ] = [ \begin{matrix}{p}_{1} \\ {p}_{2} \\ {F}_{ext} \\ {T}_{ext}\end{matrix} ]$$

where f_{c} are unknown traction forces on the fluid channel surface, u_{c} are the fluid velocity unknowns at the fluid channel inlet and outlet faces, and fₚ are the traction forces on the particle surface. The known vector on the right hand side of the equation represents the single layer contributions due to the imposed pressure at each inlet/outlet face, which excites the fluid flow within the fluid channel. The other parts (i.e., are sparse, since they represent the summation of the surface forces on the particle and don't involve the fluid channel patches. Typically, for large or complicated fluid channels, the number of unknowns on the fluid channel surface greatly exceeds those on the particle surface, which implies the tacit assumption that the number of patches on particle is much less than the number of patches on the fluid channel surface, in order for the Schur complement-based scheme proposed here to be an efficient solver. It is again noted that the Schur complement, S, is defined as

S=A−B*inv(D)*C.

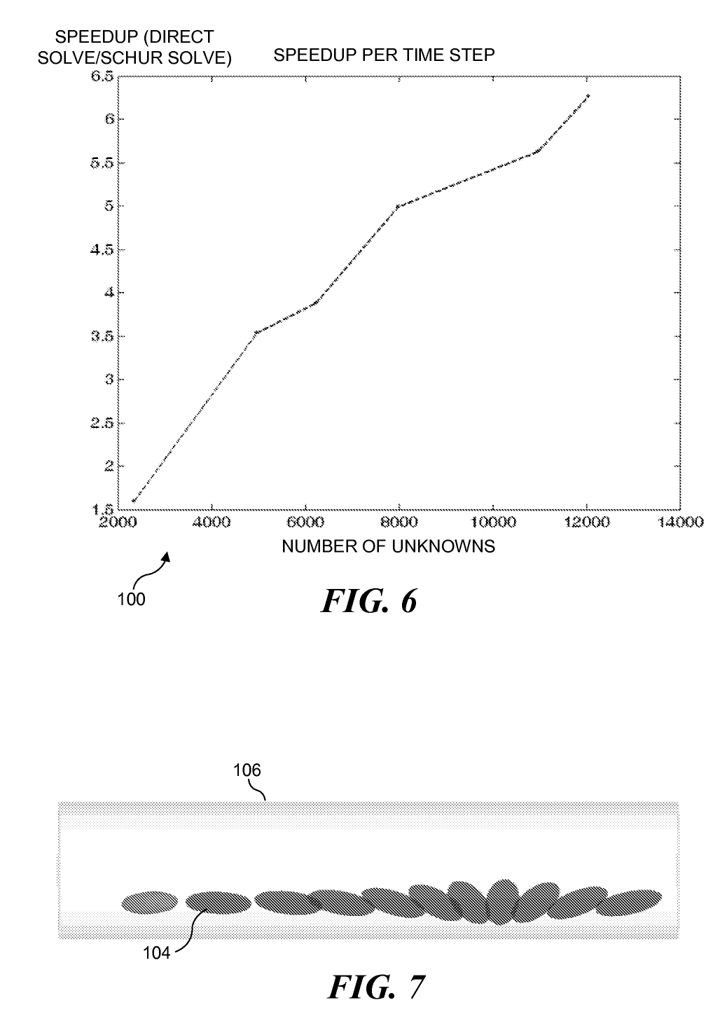

A QR-based fast iterative solver can be employed to invert the matrix in the above expression. FIG. 6 includes a graph 100 illustrating the speedup due to the present novel approach. It can be seen that for a larger number of time steps, the speedup factor is 5-6 times for each time step, compared to the conventional approach that directly solves the integral equations for each time step.

### Overview of Microfluidic Analysis of a Particle

A surface integral method is used in this exemplary approach to calculate an induced, surface charge on a surface mesh. This charge is created from potentials and electric fields that excite the interior and exterior region of a particle. A surface equivalence formula balances these potentials and fields to determine two surface integral equations. These two surface integral equations are determined by approximating a known charge basis function on the inside and outside of each triangle (or other polygon) comprising the surface mesh. When inserted within the two integral equations, a square matrix equation is generated, which can be solved using the “Fast” QR method to determine the strengths of the weights used to approximate the charge. This charge is then inserted into a post-processing step to calculate the force at the center-of-mass (COM) of the particle and the induced torque at the centroid of each triangle in the mesh.

To compute these induced charges, a two-region surface integral equation is employed. The formulation is based on satisfying the electric scalar and electric field boundary on the surface of the particle, and applying surface equivalence. Consider an arbitrary particle bounded by a surface S. The surface S is described by a triangular (or quadrilateral or other shape polygon) surface mesh. The appropriate integral equation(s) are then applied.

Design and optimization of microfluidic devices require computational tools to study low Reynolds number flow inside channels of various topology and complexity. For this application of the present approach, a Stokes equation solver using the BEM was developed to determine pressure-velocity characteristics for use in designing micro fluid channels of a LoC system. Although there is currently no BEM solver commercially available, research has shown that BEM is more accurate, can reduce problem complexity, has increased functionality, and provides more insight into microfluidic design and an accelerated speed-up of 10-100 times when integrated with a QR fast solver technique, compared to other conventional methods.

In designing pressure-driven flow to accurately control the motion of particles within microfluidic channels, advanced approaches are required. Accurate numerical methods are employed for better understanding various aspects of the problem, such as the modification of velocity profile, induced stresses and torques on a cell body or other type of particle, and the resulting motion of the cell or particle as it moves through a fluid channel. The BEM is useful in modeling particle-dynamics. Velocity driven formulations can also be used to predict particle motion within fluids. There are also 2-D studies of both velocity and pressure-driven BEM formulations.

BEM can be used to analyze particle motion inside arbitrary-shaped 3-D micro fluid channels. A pressure-driven BEM responds to a pressure-difference applied between the ends of a fluid channel, i.e., a differential pressure relative to the input face and the output face of the fluid channel. The traction forces and velocity on the faces of the channel are determined and are then used to calculate the fluid-flow profile inside the fluid channel. Once the pressure-velocity characteristics have been determined, particle motion inside the fluid channel is predicted by computing the integral equations with using the Schur complement and an explicit time-stepper, as indicated above.

A particle's trajectory is influenced by both the induced stresses from the channel as well as by external forces and external torques. A significant importance of the present method for practical design of microfluidic systems involving particle motion is the relative reduction in computational resources that is achieved. The pressure driven formulation also presents a better approach than a fixed-flow system for understanding flow fields with increasing resistance, because the applied pressure is required to increase without bound in order to preserve the same velocity in fixed-flows, whereas in pressure-driven systems, the velocities are modified according to the channel geometry. Other channel geometries can be similarly modeled and simulated using this approach

### Fast Solvers

Fast multilevel solvers (O(N)) can accelerate the computation in BEM systems for use in creating and evaluating the design of a device, such as a LoC. These solvers use a multilevel oct-tree decomposition of the given geometry and exploit rank deficient far-field interactions to compress the overall BEM system. In the present technology, a variant of the popular fast multi-pole method can be used for solving the Stokes flow kernel. A rank-revealing QR scheme has been used in the electromagnetic section and is also generally usable for these computations. The ultimate combined effect of these algorithms is a dramatic savings in computational time and reduced requirements for memory in large systems. More specifically, a linear requirement (O(N)) is applicable to the present approach, while a quadratic or cubic requirement (i.e., O(N²) or O(N³)) must be met when implementing a solution using the conventional approach.

### Schematic Block Diagram Representing Exemplary Process

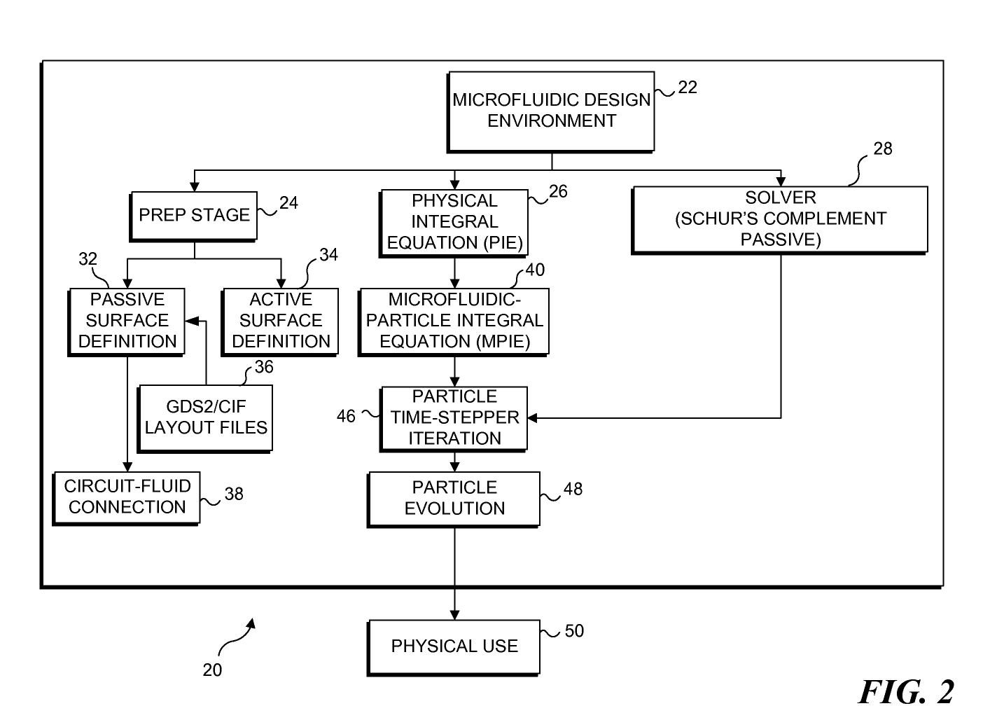

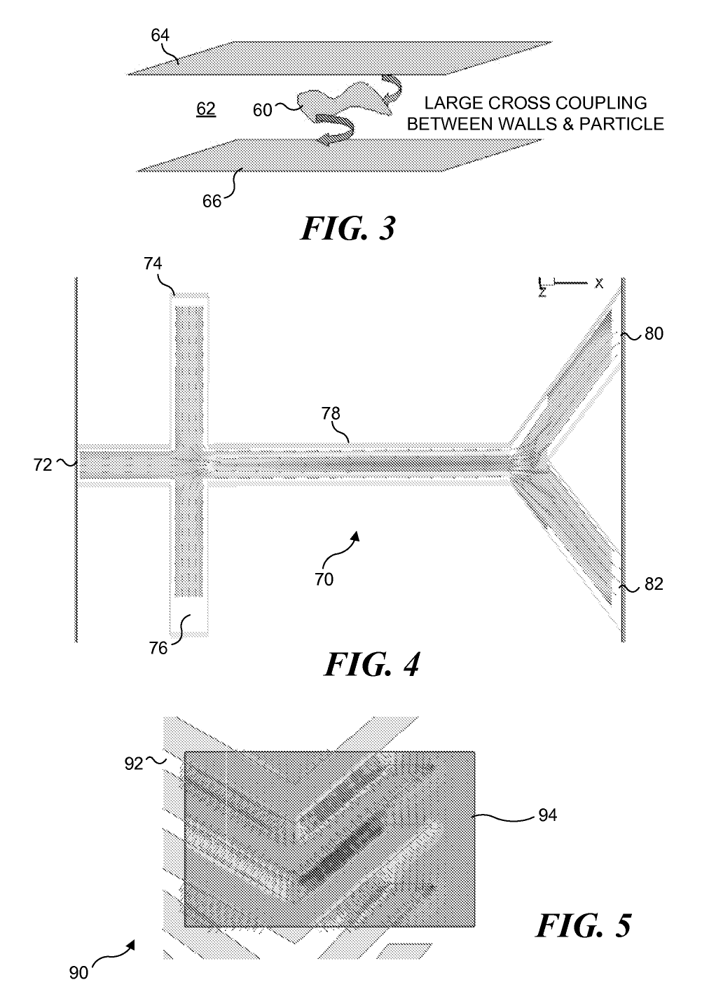

In connection with the above discussion, FIG. 2 illustrates exemplary functional steps 20 that are implemented to enable a user to determine the motion of particles within a fluid channel in a microfluidic design environment 22. A microfluidic design environment might employ a dielectrophoresis force, an electrophoresis force, a magnetophoresis force, or other types of forces acting on a particle carried in a fluid, and might also be employed in a system that combines two or more of these forces, or which combines one or more of these forces with other external forces, such as gravity. These steps thus determine the equations describing how the particle will move within a fluid channel in a simulated device when exposed to the one or more forces.

There are three steps that are generic to an exemplary microfluidic design environment 22, including carrying out a prep (or preparation) to solve the problem in a step 24, solving one or more integral equations (IE) in a step 26, and using a solver (e.g., the Schur complement—passive) in connection with the IE in a step 28. Each of these three steps can be tailored to a specific microfluidic device. For example, these steps can be implemented for evaluating the design parameters of the fluid channel in a simulated LoC device or other type of fluid channel system, in regard to one or more specific forces, such as any of those noted above, or a combination of two or more forces that act on the particle in the fluid channel of the device.

Prep stage in step 24 involves providing a passive surface mesh (i.e., triangular, rectangular, or other polygon shape mesh) describing the passive surface of the fluid channel in the microfluidic channel architecture, as indicated in a step 32. In a step 34, an active surface definition is created with a mesh (i.e., triangular, rectangular, or other polygon shape mesh) representing the one or more particles in the fluid channel. Conventional GDS2/CIF layout computer files can be used for input of the data needed to define passive surface meshes in an automated manner, as indicated in a step 36, although other types of computer data files may also be employed for this purpose. GDS2 and CIF files are standard layout files that use simple 2-D geometric polygons. In this exemplary approach, the geometric polygons are merged together. Once merged, a 2-D surface mesh is generated and is then extruded to construct a 3-D mesh, which might be based, for example, on the height of the fluid channels in the simulated device. Likewise, the surface mesh representing the particle or particles can be input in an automated fashion, or alternatively, may be manually defined by a user in step 34.

The passive surface definition provided in step 32 serves to define each circuit fluid connection in the device or system being simulated, as indicated in a step 38. While not indicated in FIG. 2, the process would also typically provide an input describing fluid parameters, such as a pressure gradient, fluid viscosity, and fluid flow. In addition, interior and exterior fluid regions would be defined for the device or system, and any unknown parameters on the active or passive surfaces would be indicated.

The specific type of IE that is implemented in step 26 depends on the forces being applied in the simulated LoC device or other type of fluid channel system. Since the device or system being simulated is implementing a microfluidic environment in this example, a step 40 provides for employing a microfluidic particle integral equation (MPIE) to compute fluid flow results, given an applied pressure gradient. The Schur complement of step 28 is used to solve the problem at successive time steps or intervals, as the particle moves through the fluid channel, as indicated in a step 46. The matrices used for the Schur complement are determined based upon the IE.

Assuming that the particle is deformable or varies in size and/or shape as it moves through the fluid channel, a step 48 addresses this particle evolution in successive time steps, by using new values for the matrix A (particle interaction with itself) when updating the Schur complement, along with the updating of the other matrices B, C, for each successive time step or interval. The inverse of matrix D remains invariant for successive time steps, so that the computational cost of this determination is substantially less than the conventional direct approach.

Once successive values describing the dynamic motion of the particle (or particles) through the fluid channel have been calculated for the successive time intervals, a step 50 employs the result of the calculation in a physical sense. For example, the dynamic behavior of the particle can be used for modifying and optimizing parameters of the fluid channel, such as its cross-sectional size or length, during the design of a LoC device or other fluid channel system. Or, the user can be presented with a visual display of a simulation showing the movement of the particle(s) through the fluid channel. Alternatively, the results can be stored on a hard drive or other non-volatile medium for subsequent use by the user. However, it should be understood that these examples of the physical use of the results of implementing the present method are not in any way intended to be limiting of the scope of this novel approach.

To analyze the pressure-velocity flow characteristics and particulate transport inside micro fluid channels (i.e., the IE), a Stokes integral equation formulation was developed. The following discussion presents an approach to the formulation and solution of a pressure driven particle-fluid flow within a micro fluid channel. Consider a confined flow in a micro fluid channel. The micro fluid channel is bounded by a domain S, where the walls of the channel are represented by S_{w}, S_{f} represents the channel faces in connection with the flow inlet and outlet, and Sₚ represents the boundaries of a particle inside the micro fluid channel. The velocity and the normal vectors at the faces are given by U_{f} and n_{f} respectively. Finally, there is a pressure applied to the inlet and outlet faces, given by p_{f}ⁱⁿ and p_{f}^{out}.

At steady state, an incompressible fluid satisfies the following equations:

μ∇²u=∇p (1)

and

∇·u=0 (2)

where μ is the fluid viscosity, p represents the pressure, and u is the velocity-field of the fluid. Eq. (1) is the Stokes equation for fluid motion at low Reynolds numbers, and Eq. (2) indicates the continuity condition for fluids. In a confined flow, the fluid motion is driven by pressures p_{f} on the channel faces S_{f}, while the no-slip conditions imply u=0 at the channel walls S_{w}. The stress tensor is given by:

$${σ}_{ij} = - p {δ}_{ij} + μ ( \frac{\partial {u}_{i}}{\partial {x}_{j}} + \frac{\partial {u}_{j}}{\partial {x}_{i}} ) . \qquad ( 3 )$$

The above system can be reduced to the following integral representation:

$${u}_{i} ( {x}_{0} ) = \frac{- 1}{4 π μ} {\int }_{D} {G}_{ij} ( x , {x}_{0} ) {f}_{j} ( x ) d S ( x ) + \frac{1}{4 π} {\int }_{D}^{PV} {u}_{j} ( x ) {T}_{ijk} ( x , {x}_{0} ) {n}_{k} ( x ) d S ( x ) \qquad ( 4 )$$

where Gᵢⱼ(x,x₀) is the fundamental singular solution, also known as Stokeslet, given by

$${G}_{ij} ( x , {x}_{0} ) = \frac{{δ}_{ij}}{r} + \frac{{\hat{x}}_{i} {\hat{x}}_{j}}{{r}^{3}} . \qquad ( 5 )$$

The second kernel Tᵢⱼₖ(x,x₀) is given by:

$${T}_{ijk} ( x , {x}_{0} ) = - 6 \frac{{\hat{x}}_{i} {\hat{x}}_{j} {\hat{x}}_{k}}{{r}^{5}} . \qquad ( 6 )$$

The repeated indices represent an Einstein summation, and the second integral requires computation of a Cauchy principle-value integral. Physically, the first integral is the single layer potential due to a distribution of point sources, while the second integral represents the double layer potential due to a distribution of point dipoles. In the case of a particle inside a channel moving with a translation velocity U and an angular velocity Ω, the total velocity on the particle surface Sₚ is given by

uₚ=U+Ω×r (7)

where r is the radial vector relative to the COM of the particle. The particle is assumed to be a rigid body, to simplify this explanation, but can alternatively be deformable, i.e., can have a varying size and/or shape. The values of U and Ω are determined by balancing any external forces and torques on the particle:

$$\begin{matrix} σ• d S = {F}_{ext} & ( 8 ) \\ & ( 9 )\end{matrix}$$

The external forces and torques are provided in this example by DEP, but other types of forces can also or alternatively be applied. The boundary conditions of the resulting interior problem at every time step are given by: (i) uⱼ=0 for every point on the channel walls S_{w} for j=1,2,3; (ii) u₂=u₃=0 at the channel inlets S_{f}; (iii) the stress force on S_{f} is given by f₁=−pⱼn₁; and, (iv) Eq. 8 and 9 provide the values at the particle surface Sₚ. The imposed condition of unidirectional flow at the micro fluid channel's inlet and outlet ensures that the original boundary value problem has a unique solution when only the pressure is prescribed on the control surfaces. The final system of equation is then given by:

$$\begin{matrix}0 , & for {x}_{0} ∈ {S}_{w} \\ {u}_{i} ( {x}_{0} ) , & for {x}_{0} ∈ {S}_{p} \\ {u}_{i} ( {x}_{0} ) {δ}_{i 1} , & for {x}_{0} ∈ {S}_{f}\end{matrix} \} = \frac{- 1}{4 π μ} {\int }_{{S}_{f} ⋃ {S}_{w} ⋃ {S}_{p}} {G}_{ij} ( x , {x}_{0} ) {f}_{j} ( x ) d S ( x ) + \frac{1}{4 π} {\int }_{{S}_{p} ⋃ {S}_{f}} {u}_{j} ( x ) {T}_{ijk} ( x , {x}_{0} ) {n}_{k} ( x ) d S ( x ) . \qquad ( 10 )$$

In connection with the above discussion, FIG. 12 illustrates exemplary streamlines and stress distribution due to pressure induced fluid flow in an H-shaped fluid channel 150 having two inlets 152 and 154, joining in a common portion 156 of the fluid channel, which then splits toward two opposite output ports 158 and 160.

In FIG. 13, a simulated surface mesh (triangular) for a four arm spiral inductor 170 is illustrated as an example of a configuration in which magnetic forces are applied to the particles in a fluid channel. Superimposed on the mesh is a plot of an intensity 172 of the electric field (just slightly above the electrodes that are used in this configuration to produce the electric field). The strength of the electric field intensity is strongest near the edges of the electrodes and increases in strength toward the center of the array.

A solution that determines the unknowns for dynamic particle motion for a generalized microfluidic architecture is non-trivial and requires careful integration of layouts into 3-D surface meshes, correct integral equation evaluations, and efficient solutions.

### Surface Equivalent DEP Force Calculations

Dielectrophoresis or DEP is a widely used technique for the sorting of different charge neutral bio-species. The DEP force can be calculated exactly, to enable the effects of such a force to be simulated in a LoC device or other type of fluid channel system. The inherent technological process includes a surface integral method that calculates an induced surface charge on a surface mesh. This charge is produced by potentials and electric fields that excite its interior and exterior regions. A surface equivalence formula balances these potentials and fields to determine two surface integral equations. The two surface integral equations are determined by approximating a known charge basis function on the inside and outside of each triangle (or other type of polygon that is used) for the surface mesh. When inserted within the two integral equations, a square matrix equation is generated that is solved as described above.

As discussed above, FIG. 2 illustrates exemplary functional steps used to implement the present novel approach. Further details of the process are discussed below.

### Prep Stage

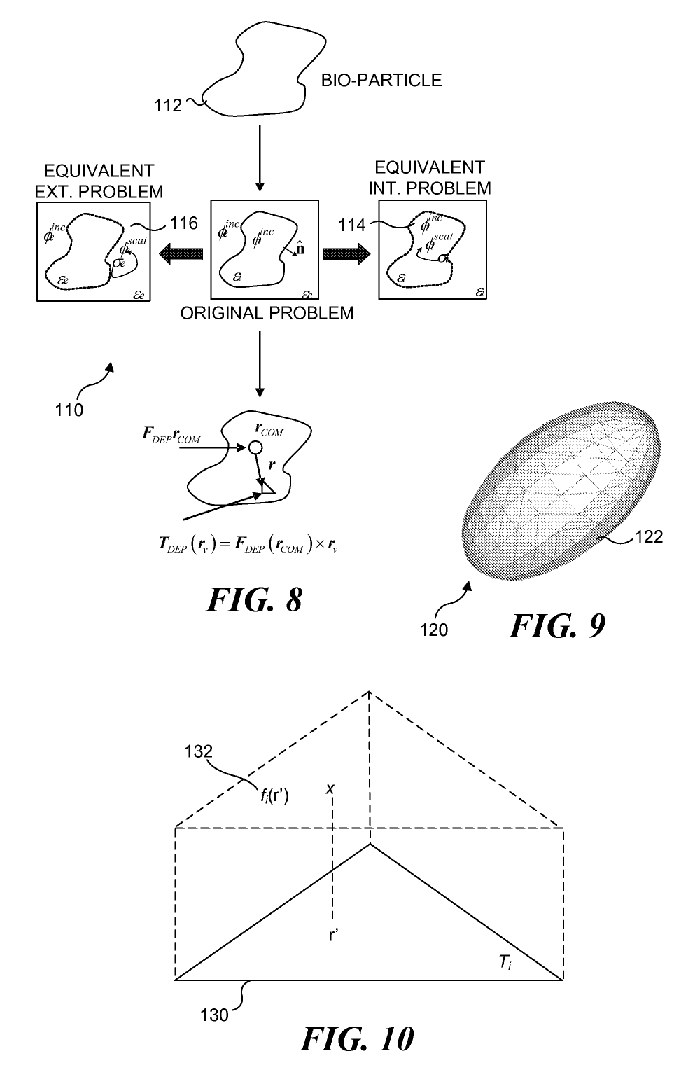

The prep stage of step 24 of the process creates the information and data structures necessary to begin calculating the dynamic motion of a particle in a LoC device or other fluid channel system. Step 34 is directed to an arbitrary-shaped particle of interest, such as an E. Coli bacterium, yeast cell, etc. The user must input a surface mesh to represent the surface of this particle, and then specify the region information disposed on each side of the surface mesh (for example, as shown in FIG. 8).

### Surface Mesh

The surface mesh must be described in terms of either triangular or quadrilateral (or other polygonal) surface elements. An exemplary mesh 122 of a yeast cell 120 (e.g., a spheroid) is shown in FIG. 9. The mesh is described by terms of different input files. Specifically, a node list file describes the location in space of each node of each triangle (or other type of polygon used for the surface mesh), and a patch list file describes for each triangle (or other type of polygon that is used), the nodes to which it is connected, providing data input to the Schur complement solver as geometric information.

### Region Information

The approach used in this example is based on the surface equivalence principle for electrostatics. This approach decomposes a particle into an interior region 114 and an exterior region 116, with a surface separating the regions, as shown in a schematic flow chart 110 for a bio-particle 112 in FIG. 8. The surface is described by the surface mesh (as explained above) on which an equivalent surface charge density for both interior region 114 and exterior region 116 is specified. The strength of the charges on each region depends on the strength of the fields within each region, as described by the material composition in the region. The region information is a data structure that enables the user to specify the characteristics of the exterior region or the interior composition of the particle. For the purposes of calculating either DEP or electrophoresis forces, the material composition is described by the permittivity in each region, which is a function of frequency (or wavelength), conductivity, and permittivity, as follows:

$${ɛ}_{v} = {ɛ}_{o} - \frac{jσ}{ω} \qquad ( 11 )$$

where the subscript v refers to either the interior region or the exterior region. FIG. 8 illustrates how the DEP force and torque on the bio-particle are then represented as a function of the radial distance of the field source from the COM of the particle.

If the particle is described by different material regions, then region information must also be included for each of the other different regions. For instance, in many biological particles (e.g., E. Coli), a user can represent the particle by a shell model or by a multi-layer model description. In this case, the object must be described by different surface meshes that provide the interfaces between each region, and must specify the region information on either side of a given surface. In this manner, a user can begin to build a quantitative model with accurate DEP calculations on realistic particles for a simulation instead of simply using analytical calculations of DEP for spheres or other canonical objects.

### Surface Charge Density

An equivalent surface charge density may be produced on the surface meshes of the particles in some fluid channel configurations. To solve the surface integral equation, the charge density for each triangle in a given surface mesh must be approximated. In this novel technology, there are two excited surface charge densities, an interior charge density and an exterior charge density, each of which is induced. The charge density across each surface element is approximated using a source basis function and is written as a sum of the product of unknown charge coefficients times the source basis function defined across each element:

$${σ}_{v} ( {r}^{′} ) ≅ {\sum }_{i = 1}^{n} {σ}_{v}^{( i )} {f}_{i} ( {r}^{′} ) \qquad ( 12 )$$

where v is the region index (i.e., indicating either interior or exterior), n is the total number of basis functions on the conductor surface, and σᵥ⁽ⁱ⁾ is the strength of the (i-th) basis function, which must be determined. The source basis function fᵢ is a pulse basis function, which has value equal to 1 on element i and a value equal to 0 everywhere else. FIG. 10 illustrates an example of the pulse basis function 132 for a triangle 130, indicated by Tᵢ.

$${f}_{i} ( r ) = \{ \begin{matrix}1 & r ∈ {Δ}_{i} \\ 0 & otherwise\end{matrix} \qquad ( 13 )$$

### Surface Equivalent DEP Integral Equation:

To compute induced charges, a two-region surface integral equation is employed. The formulation is based on satisfying the electric scalar and electric field boundary on the surface of the particle and then applying surface equivalence. Consider an arbitrary particle bounded by a surface S. The surface S is described by a triangular (or quadrilateral or other polygon) surface mesh. The appropriate integral equations are applied, as described in the following section.

### Equivalent Electric Scalar Potential Integral Equation

The continuity of the scalar potential across surface S of a particle is given by:

$$- {\int }_{S} d s {\int }_{S} {G}_{e} ( r , {r}^{′} ) {σ}_{e} d {s}^{′} + {\int }_{S} d s {\int }_{S} {G}_{i} ( r , {r}^{′} ) {σ}_{i} d {s}^{′} = {\int }_{S} d s {φ}_{e}^{inc} - {\int }_{S} d s {φ}_{i}^{inc} \qquad ( 14 )$$

where the subscripts i and e represent the interior and the exterior of the object. The superscript inc represents incident fields produced by interior or exterior exciting potentials.

For this formulation, the electrostatic Green's function is given by the permittivity in each region,

$${G}_{v} ( r , {r}^{′} ) = \frac{1}{4 {πɛ}_{v} \vert r - {r}^{′} \vert} \qquad ( 15 )$$

where and r and r′ are position vectors of the observation and source points respectively. The permittivity in each region is described above.

An unknown σₛ is the equivalent surface charge density. This unknown can be determined by convolving the Green's function with the charge density over the surface of the given particle.

An important aspect of this step is that the equivalent surface principle requires two types of charges to be induced, specifically, an equivalent interior charge, σᵢ and an equivalent exterior charge, σₑ. These charges are induced by potentials from the interior and exterior surfaces. For most cases, the interior electric potential is zero, for no other reason than because there is rarely an incident source inside a particle.

The exterior electric potential is normally the exciting source on a particle. There are two ways to calculate this incident electric potential, including: (1) EM-CKT technology; and, (2) using an external potential map. Either method requires evaluating the potential at the centroid of each surface element (e.g., at the center of each triangle) comprising the surface mesh.

### The Equivalent Electric Field Integral Equation

Taking the gradients of the potential leads to a computation of the electric flux density, the normal component of which is continuous across the particle surface, which is enforced by the following equation:

$$\hat{n} \cdot {ɛ}_{e} {\int }_{S} d s ∇ {\int }_{S} {G}_{e} ( r , {r}^{′} ) {σ}_{e} d {s}^{′} - \hat{n} \cdot {ɛ}_{i} {\int }_{S} d s ∇ {\int }_{S} {G}_{i} ( r , {r}^{′} ) {σ}_{i} d {s}^{′} = \hat{n} \cdot {ɛ}_{e} {\int }_{S} d {sE}_{s}^{inc} - \hat{n} \cdot {ɛ}_{i} {\int }_{S} d {sE}_{i}^{inc} \qquad ( 16 )$$

where \hat{n} is the unit normal of the surface S pointing in the outward direction. Upon discretization of the particle surface, a complete set of linear equations can be produced and solved to yield the equivalent charge densities on the surface of a particle.

### Integral Equation Evaluation

To excite each of the integral equations, it is necessary to calculate the exciting electric potential and electric field at the centroid of each triangle in the surface mesh.

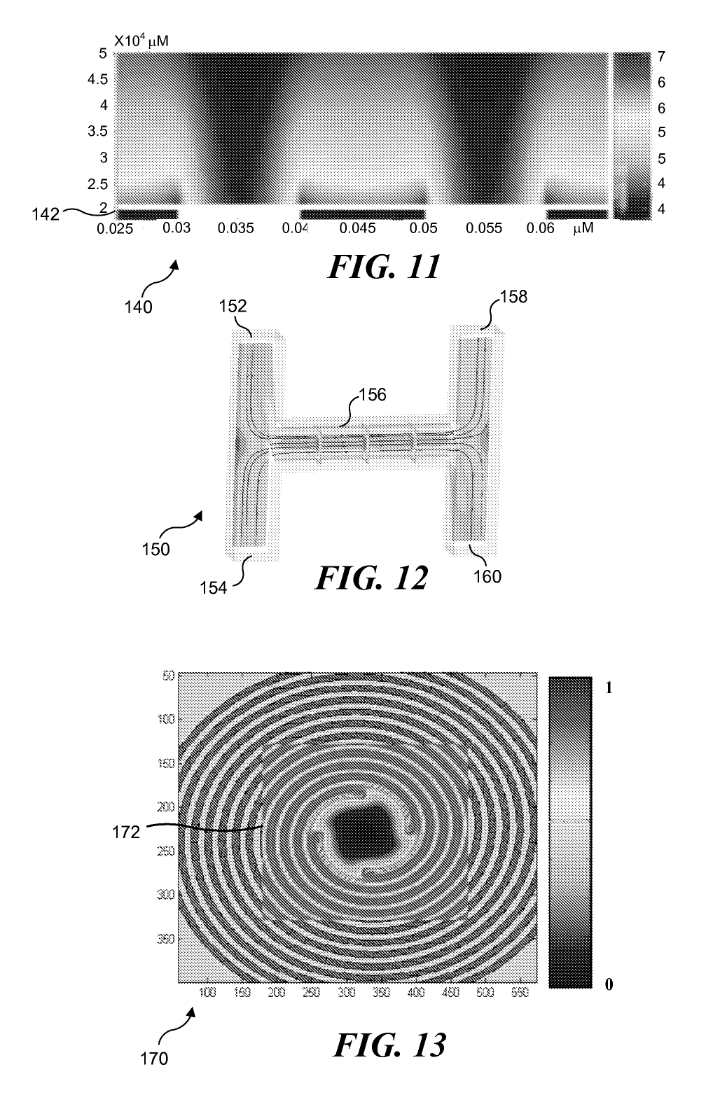

There are two different ways to calculate the incident potential and fields on the surface of an object. The first manner is to create an electric potential and field map, which can be a post-processing step that generates the information in a space surrounding the particle. Then, an interpolation is done between the map and the required potential and field evaluations on the centroid of each triangle. A field map data file is used for input to the computer program that carries out this step. An example of electric field and potential plots 140 produced by one approach is shown in FIG. 11. DEP is usually calculated with respect to an electrode array 142 (or a spiral array).

The circuit-EM code can be used to generate the potentials and electric fields produced by each of these arrays. A MAP is created that is then used to interpolate the incident scalar electric and incident electric field to calculate the DEP force on a particle above each type of array.

### Solving for the Equivalent, Induced Surface Charge

To obtain a solution that determines the surface charge density, the method of moments (MoM) can be applied by substituting Eq. (15) into Eq. (14) and Eq. (16) to yield equations of the form:

$$φ ( r ) = \frac{1}{4 {πɛ}_{o}} {\sum }_{i = 1}^{n} {ρ}^{( i )} \int d {r}^{′} \frac{{f}_{i} ( {r}^{′} )}{\vert r - {r}^{′} \vert} . \qquad ( 17 )$$

However, the number of “degrees of freedom” in this equation is only N. Clearly this equation cannot in general be enforced at every arbitrary point on the surface S. In fact, it can at most only be enforced at N points. The manner in which N equations are developed gives rise to different MoM approximations.

To generate an N by N system of equations, a testing function tₘ is applied at a different element (m) to evaluate the potential interaction at this element due to the source at element (n). Taking the inner product φ(r) (which is an integral over the surface of the testing function) with tₘ, results in the following:

<tₘ(r),φ(r)>=∫ₛ tₘ(r)φ(r)dS, for m=1, 2 . . . N. (18)

Inserting the surface charge density results in:

$$< {t}_{m} ( r ) , φ ( r ) >= \frac{1}{4 {πɛ}_{o}} {\sum }_{i = 1}^{n} {ρ}^{( i )} {\int }_{s} {t}_{m} ( r ) {\int }_{{S}^{′}} \frac{{f}_{i} ( {r}^{′} )}{\vert r - {r}^{′} \vert} d {S}^{′} d S , \\ for m = 1 , 2 … N . \qquad ( 19 )$$

The preceding equation defines a matrix of size N by N. To better understand this point, the equation can be written out by summing over the sources and testing at each element m:

(m=1) <t₁(r),φ₁(r)>ρ⁽¹⁾+<t₁(r),φ₂(r)>ρ⁽²⁾+ . . . +<t₁(r),φ_{N}(r)>ρ^{(N)}=<t₁(r),V(r)>

(m=2) <t₂(r),φ₁(r)>ρ⁽¹⁾+<t₂(r),φ₂(r)>ρ⁽²⁾+ . . . +<t₂(r),φ_{N}(r)>ρ^{(N)}=<t₂(r),V(r)>

(m=N) <t_{V}(r),φ₁(r)>ρ⁽¹⁾+<t_{N}(r),φ₂(r)>ρ⁽²⁾+ . . . +<t_{N}(r),φ_{N}(r)>ρ^{(N)}=<t_{N}(r),V(r)> (20)

where φₙ refers to the integral over the source basis function:

$${φ}_{n} ( r ) = \frac{1}{4 {πɛ}_{o}} {\int }_{{S}^{′}} \frac{{f}_{n} ( {r}^{′} )}{\vert r - {r}^{′} \vert} d {S}^{′} . \qquad ( 21 )$$

This expression can be rewritten in matrix form as:

$$[ \begin{matrix}< {t}_{1} ( r ) , {φ}_{1} ( r ) > & < {t}_{1} ( r ) , {φ}_{2} ( r ) > & … & < {t}_{1} ( r ) , {φ}_{N} ( r ) > \\ < {t}_{2} ( r ) , {φ}_{1} ( r ) > & < {t}_{2} ( r ) , {φ}_{2} ( r ) > & … & < {t}_{2} ( r ) , {φ}_{N} ( r ) > \\ … & … & < {t}_{m} ( r ) , {φ}_{n} ( r ) > & … \\ < {t}_{N} ( r ) , {φ}_{1} ( r ) > & < {t}_{N} ( r ) , {φ}_{2} ( r ) > & … & < {t}_{N} ( r ) , {φ}_{N} ( r ) >\end{matrix} ] [ \begin{matrix}{ρ}^{( 1 )} \\ {ρ}^{( 2 )} \\ … \\ {ρ}^{( N )}\end{matrix} ] = [ \begin{matrix}< {t}_{1} ( r ) , V ( r ) > \\ < {t}_{2} ( r ) , V ( r ) > \\ … \\ < {t}_{N} ( r ) , V ( r ) >\end{matrix} ] \qquad ( 22 )$$

and in compact form as:

Z̅_{m×n}I_{n×1}=V_{m×1} (23)

where a value in matrix Z is given by testing at element (m) due to a source basis function at element (n).

$${Z}_{mn} = < {t}_{m} ( r ) , {φ}_{n} ( r ) > \frac{1}{4 {πɛ}_{o}} {\int }_{s} {t}_{m} ( r ) {\int }_{{S}^{′}} \frac{{f}_{n} ( {r}^{′} )}{\vert r - {r}^{′} \vert} d {S}^{′} d S \qquad ( 24 )$$

### DEP Post-Processing Force and Torque Calculation

The novelty of this methodology is also reflected in the calculation of the DEP force and torque. Other methods, given a charge density, could calculate the force due to this charge density as:

F=qE(r) (25)

Instead, the induced charge on the surface of the particle is used to calculate an equivalent surface force. The equivalent DEP force can then be calculated at a location in space, by the following:

$$F = - {\int }_{S} {σ}_{e} ( r ) d s ∇ {\int }_{S} {G}_{e} ( r , {r}^{′} ) {σ}_{e} ( {r}^{′} ) d {s}^{′} + {\int }_{S} d s {σ}_{e} ( r ) {E}_{e}^{inc} . \qquad ( 26 )$$

In general, this step would be used in a force-stepping algorithm, where rigid body dynamics are often an underlying assumption. Therefore, it is only necessary to calculate the DEP (or electrophoretic) force at the center of mass of the particle.

To calculate the DEP torque on a particle, the cross-product of the DEP force evaluated at the centroid of each triangle (or other polygon patch) with the vector between the center-of-mass and the centroid of the triangle is determined. The surface equivalence torque calculation is determined as follows:

$${T}_{DEP} ( {r}_{v} ) = {\sum }_{v = 1}^{N} ( {r}_{v} - {r}_{com} ) \times {F}_{DEP} ( {r}_{v} ) . \qquad ( 27 )$$

### Exemplary Computing System for Use in Determining Particle Motion

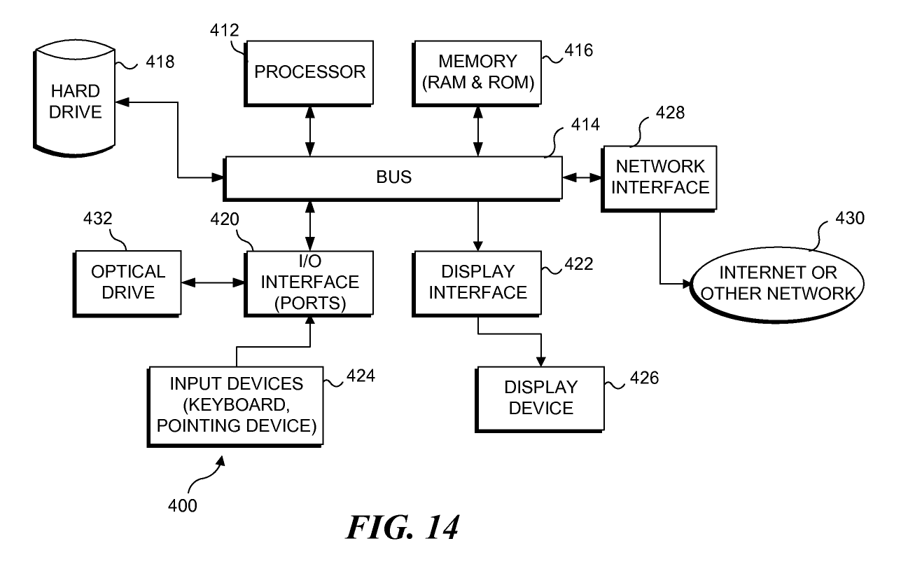

FIG. 14 illustrates details of a functional block diagram for an exemplary computing device 400, which can be employed to determine particle dynamics within a fluid channel. The computing device can be a typical personal computer, but can take other forms. For example, the computing device can be implemented as a laptop, desktop, or server, to name a few such devices, without any intended limitation.

A processor 412 is employed in the exemplary computing device for executing machine instructions that are stored in a memory 416. The machine instructions may be transferred to memory 416 from a data store 418 over a generally conventional bus 414, or may be provided on some other form of memory media, such as a digital versatile disk (DVD), a compact disk read-only memory (CD-ROM), or other non-volatile memory device. Processor 412, memory 416, and data store 418, which may be one or more hard drive disks or other non-volatile memory, are all connected in communication with each other via bus 414. The machine instructions are readable by the processor and executed by it to carry out the functions discussed above in regard to the present approach for determining particle motion in a fluid channel. Also connected to the bus are a network interface 428 which couples to the Internet or other network 430, an input/output interface 420 (which may include one or more data ports such as a serial port, a universal serial bus (USB) port, a Firewire (IEEE 1394) port, a parallel port, a personal system/2 (PS/2) port, etc.), and a display interface or adaptor 422. Any one or more of a number of different input devices 424 such as a keyboard, mouse or other pointing device, trackball, touch screen input, etc., are connected to I/O interface 420. A monitor or other display device 426 is coupled to display interface 422, so that a user can view graphics and text produced by the computing system as a result of executing the machine instructions, both in regard to an operating system and any applications being executed by the computing system, enabling a user to interact with the system. For example, a simulation illustrating the motion of a particle through a fluid channel can be displayed to a user based upon the results of the determination discussed above. FIG. 7 illustrates a simulation of the motion of a platelet 104 within a pressure driven micro fluid channel 106 of a LoC, as an example that shows how the dynamic motion of a particle within the fluid channel might be displayed to a user. An optical drive 432 is included for reading (and optionally writing to) CD-ROMs, a DVD, or some other form of optical memory medium. The results of the determination can optionally be stored on hard drive 418 (or other non-volatile memory) for later use.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for efficiently determining the motion of a particle through a fluid channel in response to forces and torques acting on the particle in a series of successive time intervals, comprising the steps of:
(a) creating a description of a mesh that defines boundary surfaces of the fluid channel;
(b) creating a description of a mesh that defines a surface of the particle that is moving through the fluid channel;
(c) formulating a system of equations that define force and velocity interactions between the particle and the fluid channel in regard to movement of the particle through the fluid channel;
(d) based on the system of equations, determining:
(i) a first matrix defining an interaction between the boundary surface of the fluid channel and itself, values comprising the first matrix remaining constant in time as the particle moves through the fluid channel;
(ii) a second matrix defining an interaction between the particle and itself, values comprising the second matrix remaining constant in time if the particle is rigid, but changing over time if the particle deforms while moving through the fluid channel;
(iii) a third matrix defining an interaction between the particle and the fluid channel, values comprising the third matrix varying in time as the particle moves through the fluid channel; and
(iv) a fourth matrix defining an interaction between the fluid channel and the particle, values comprising the fourth matrix varying in time as the particle moves through the fluid channel;
(e) determining an inverse of the first matrix for use in the Schur complement, the second, third, and fourth matrices also being used in the Schur complement;
(f) for each successive time interval, iteratively updating the Schur complement, for determining a dynamic behavior of the particle as it moves through the fluid channel, the dynamic behavior of the particle being indicated by a velocity of the particle at an input face and at an output face of the fluid channel, forces on the boundary surfaces of the fluid channel, and traction forces on the surface of the particle for the time interval; and
(g) employing the dynamic behavior of the particle that was determined for the successive intervals of time, to implement a physical result related to the movement of the particle through the fluid channel.

2. The method of claim 1, wherein the physical result is achieved by carrying out at least one step selected from the group of steps consisting of:
(a) displaying a visual representation corresponding to the dynamic behavior of the particle moving through the channel;
(b) employing the dynamic behavior of the particle for a design iteration to modify or optimize parameters affecting movement of particles within the fluid channel; and
(c) storing values representative of the dynamic behavior of the particle as it moves through the fluid channel, for subsequent display or use by a user.

3. The method of claim 1, wherein the step of formulating the system of equations comprises the step of creating an integral representation of the particle movement through the fluid channel for incompressible Stokes fluid flow.

4. The method of claim 3, further comprising the step of applying no-slip and pressure boundary conditions to the boundary surface of the fluid channel when formulating the system of equations.

5. The method of claim 4, wherein the step of applying no-slip boundary conditions to the boundary surface of the fluid channel comprises the step of setting velocity components at the boundary surfaces equal to zero.

6. The method of claim 1, further comprising the step of accounting for traction forces applied on inlet and outlet faces of the fluid channel, based on pressure gradients within the fluid channel.

7. The method of claim 1, wherein the step of formulating the system of equations comprises the step of accounting for net external forces and torque applied to the surface of the particle that produce translational and rotational velocities of the particle as it moves through the fluid channel.

8. The method of claim 1, wherein the step of determining an inverse of the first matrix comprises the step of employing a low rank-based fast solver to determine the inverse of the first matrix.

9. The method of claim 1, further comprising the step of storing the inverse of the first matrix after it is determined for a first of the successive time intervals, for use in updating the Schur complement for each of the remaining successive time intervals.

10. The method of claim 9, further comprising the step of storing the second matrix, for use in updating the Schur complement for each of the successive time intervals.

11. A system for efficiently determining the motion of a particle through a fluid channel in response to forces and torques acting on the particle in a series of successive time intervals, comprising:
(a) a memory in which are stored machine executable instructions;
(b) a display; and
(c) a processor that is coupled to the memory and the display, the processor executing the machine executable instructions to carry out a plurality of functions, including:
(i) receiving input data comprising a mesh that defines boundary surfaces of the fluid channel, and a mesh that defines a surface of the particle that is moving through the fluid channel;
(ii) enabling a user to input a system of equations that define force and velocity interactions between the particle and the fluid channel in regard to movement of the particle through the fluid channel;
(iii) based on the system of equations, determining:
(A) a first matrix defining an interaction between the boundary surface of the fluid channel and itself, values comprising the first matrix remaining constant in time as the particle moves through the fluid channel;
(B) a second matrix defining an interaction between the particle and itself, values comprising the second matrix remaining constant in time if the particle is rigid and non-deforming, but changing over time if the particle deforms while moving through the fluid channel;
(C) a third matrix defining an interaction between the particle and the fluid channel, values comprising the third matrix varying in time as the particle moves through the fluid channel; and
(D) a fourth matrix defining an interaction between the fluid channel and the particle, values comprising the fourth matrix varying in time as the particle moves through the fluid channel;
(iv) determining an inverse of the first matrix for use in the Schur complement, the second, third, and fourth matrices also being used in the Schur complement;
(v) for each successive time interval, iteratively updating the Schur complement for determining a dynamic behavior of the particle as it moves through the fluid channel, including determining a velocity of the particle at an input face and at an output face of the fluid channel, forces on the boundary surfaces of the fluid channel, and traction forces on the surface of the particle for the time interval; and
(vi) employing the dynamic behavior of the particle that was determined for the successive intervals of time, to implement a physical result related to the movement of the particle through the fluid channel.

12. The system of claim 11, wherein the machine executable instructions further cause the processor to achieve the physical result by carrying out at least one function selected from the group of functions consisting of:
(a) displaying a visual representation corresponding to the dynamic behavior of the particle moving through the channel;
(b) employing the dynamic behavior of the particle for a design iteration to modify or optimize parameters affecting movement of particles within the fluid channel; and
(c) storing values representative of the dynamic behavior of the particle as it moves through the fluid channel, for subsequent display or use by a user.

13. The system of claim 11, wherein the system of equations comprises an integral representation of the particle movement through the fluid channel for incompressible Stokes fluid flow.

14. The system of claim 13, wherein no-slip and pressure boundary conditions are applied to the boundary surface of the fluid channel when formulating the system of equations input by the user.

15. The system of claim 14, wherein the no-slip boundary conditions are achieved by setting velocity components at the boundary surfaces equal to zero.

16. The system of claim 11, wherein traction forces applied on the inlet and outlet faces of the fluid channel in determining the dynamic motion of the particle are based on pressure gradients within the fluid channel.

17. The system of claim 1, wherein the system of equations is formulated to account for net external forces and torque applied to the surface of the particle to produce translational and rotational velocities of the particle as it moves through the fluid channel.

18. The system of claim 11, wherein the machine executable instructions cause the processor to determine the inverse of the first matrix by employing a low rank-based fast solver.

19. The system of claim 11, wherein the machine instructions cause the processor to store the inverse of the first matrix after it is determined for a first of the successive time intervals, for use in updating the Schur complement for each of the remaining successive time intervals.

20. The system of claim 19, wherein the machine instructions cause the processor to store the second matrix, for use in updating the Schur complement for each of the successive time intervals.

21. A memory medium storing machine readable and executable instructions for determining the motion of a particle through a fluid channel in response to forces and torques acting on the particle in a series of successive time intervals, said instructions being employed for carrying out a plurality of functions, including:
(a) receiving input data comprising a mesh that defines boundary surfaces of the fluid channel, and a mesh that defines a surface of the particle that is moving through the fluid channel;
(b) receiving input of a system of equations that define force and velocity interactions between the particle and the fluid channel in regard to movement of the particle through the fluid channel;
(c) based on the system of equations, automatically determining:
(i) a first matrix defining an interaction between the boundary surface of the fluid channel and itself, values comprising the first matrix remaining constant in time as the particle moves through the fluid channel;
(ii) a second matrix defining an interaction between the particle and itself, values comprising the second matrix remaining constant in time if the particle is rigid and non-deforming, but changing over time if the particle deforms while moving through the fluid channel;
(iii) a third matrix defining an interaction between the particle and the fluid channel, values comprising the third matrix varying in time as the particle moves through the fluid channel; and
(iv) a fourth matrix defining an interaction between the fluid channel and the particle, values comprising the fourth matrix varying in time as the particle moves through the fluid channel;
(d) determining an inverse of the first matrix for use in the Schur complement, the second, third, and fourth matrices also being used in the Schur complement; and
(e) for each successive time interval, iteratively updating the Schur complement for determining a dynamic behavior of the particle as it moves through the fluid channel, including determining a velocity of the particle at an input face and at an output face of the fluid channel, forces on the boundary surfaces of the fluid channel, and traction forces on the surface of the particle for the time interval.
